(19) United States
(12) Patent Application Publication
(10) Pub. No.: US 2016/0095060 A1
(43) Pub. Date: Mar. 31, 2016

(54) METHOD AND APPARATUS FOR POWER OPTIMIZED IoT COMMUNICATION

(71) Applicant: Intel Corporation, Santa Clara, CA (US)

(72) Inventors: Parmoon Seddighrad, Portland, OR (US); Ashoke Ravi, Hillsboro, OR (US); Georgios Palaskas, Portland, OR (US); Per Hammarlund, Hillsboro, OR (US)

(73) Assignee: Intel Corporation, Santa Clara, CA (US)

(21) Appl. No.: 14/498,572

(22) Filed: Sep. 26, 2014

(51) Int. Cl. H04W 52/02; H04W 4/00

(52) U.S. Cl. CPC H04W 52/0225; H04W 4/008

(57) ABSTRACT

The disclosure relates to a method, apparatus and system to provide an integrated HUB for communicating with wearable devices. The exemplary devices include an Offloading engine to communicate directly with the wearable devices at reduced power and with relaxed radio specification requirement. In one embodiment, the disclosure relates to a system having one or more antennas; a platform radio to communicate with the one or more antennas; a platform processor to communicate with the platform radio; and a first logic to combine incoming data from one or more wearable sensors, the first logic configured to fuse incoming data from the one or more wearable sensors and to determine whether to awaken the host platform.

### BACKGROUND

1. Field

The disclosure relates to a method, apparatus and system to provide power optimized Internet-of-Things (IoT) communication. Specifically, the disclosure relates to a method, apparatus and system to provide an integrated HUB for receiving information from wearable IoT devices.

2. Description of Related Art

IoT is the interconnection of uniquely identifiable radio-enabled computing devices within the existing Internet infrastructure. IoT offers advanced connectivity of devices, systems and services that extends beyond machine-to-machine (M2M) communications and covers a variety of protocols, domains and applications. The interconnection of these embedded devices is expected to exponentially expedite automation in nearly all fields while also advancing applications like the so-called Smart Grid. Things, in the IoT, include a variety of devices such as heart monitoring devices, biochip transponders, automobiles sensors or field operation devices. By way of example such sensors may be arranged to assist fire-fighters in search and rescue. Current market examples also include smart thermostat systems, heart rate monitor and wrist watches that monitor movement and sleep patterns. The industry is seeing the proliferation of wearable IoT devices in order to enable new classes of user experiences that include seamless and continuous interaction.

Many of the IoT devices are carried on the users or are embedded in devices where they are always on and connected to the cloud. The cloud continually aggregates data from these devices, processes the data and fuse related data from different devices to arrive at suitable conclusions. At the same time many of these wearable devices have a low-battery capacity and the continual cloud communication is detrimental to their battery life.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows an exemplary environment for implementing an embodiment of the disclosure;

FIG. 2 shows a device according to one embodiment of the disclosure;

FIG. 3 is a schematic representation of a wearable or IoT hub according to one embodiment of the disclosure;

FIG. 4A schematically shows a conventional platform connectivity chip;

FIG. 4B schematically shows a platform connectivity chip according to one embodiment of the disclosure;

FIG. 4C illustrates a conventional architecture model for IEEE 802.11 protocol;

FIG. 5 schematically shows an exemplary system according to one embodiment of the disclosure; and

FIG. 6 is a flow diagram of an exemplary implementation of a process according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld-device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/03G8r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local, and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth, low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal, antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet” a WPAN, a WVAN and the like.

Smartphone owners carry their smartphones on them nearly all the time. Since the smartphone is almost always connected to the cloud through cellular/WiFi connectivity, it may be a good conduit for the IoT devices to access the cloud. The smartphone also provides a convenient HUB for sensors, appliances, wearables and can perform the first level of analyzing and fusing data from different sources to enhance user experience. The data rates involved in communicating with the IoT devices is very low and bursty (e.g., heart rate monitor, fitness, activity, notifications, etc.). The link between the wearables/IoT and the phone is a short range since the devices are on the body of the smartphone user. A short range may be in a range of about 0-2 feet, 0-4 feet or 0-6 feet. A typical link devices may be a low rate protocol such as BLE. In one embodiment, the disclosure relates to a mechanism to efficiently offload the BLE communication with the IoT devices to reduce power dissipation and increase battery life while still providing access to the cloud and the computational capabilities of the smartphone.

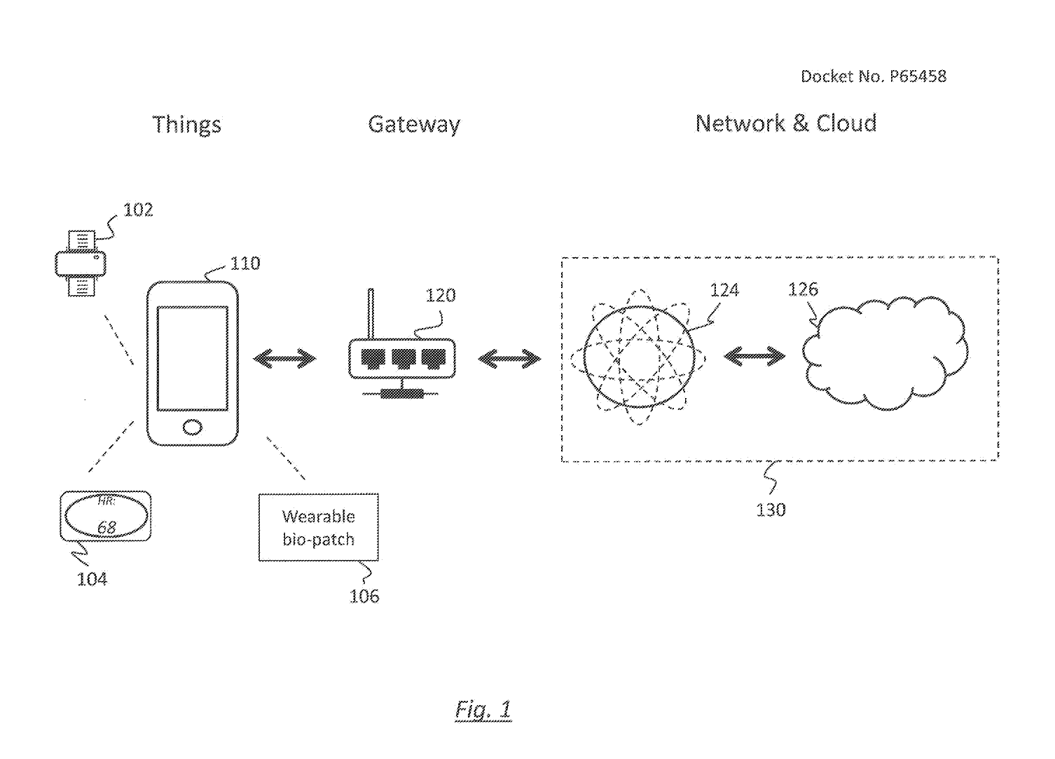

FIG. 1 shows an exemplary environment for implementing an embodiment of the disclosure. In the environment of FIG. 1, devices (wearable IoTs) 102, 104, 106 communicate with smartphone 110. Device 102 is a smartwatch, device 104 is a wearable heart-rate monitor and device 106 is a wearable bio-patch. Devices 102, 104 and 106 are exemplary and may include other common IoTs. Devices 102, 104 and 106 communicate with smartphone 110 with short, bursty and continual signals. While a smartphone is used to illustrate the concept of a HUB for IoT devices, the disclosure is not limited thereto and any communication device with similar communication capacity may be used instead of a smartphone.

Smartphone 110 communicates with Gateway 120. Gateway 120 may comprise a router, a modem, a base station or any other device configured for wireless communication. Gateway 120 communicates with network and cloud infrastructure 130. Network infrastructure 124 includes hardware and software resources that enable network connectivity, communication, operations and management of the entire network. Network infrastructure 124 also provides communication paths between users, processes and external networks. Cloud 126 represents data center infrastructure having different servers and databases.

In a conventional application, data from heart rate monitor 104 is communicated to designated servers (not shown) in cloud 126 for processing. Additional Information from smartwatch 102, wearable bio-patch 106 and smartphone 110 may also be routed to cloud 126. The gathered information may then be combined (interchangeably, fused) and analyzed to reach certain conclusions or make educated observations. For example, the data from heart rate monitor 104 can show an increased heart rate. Data from wearable body patch may show increase in the user's pulse rate while data, from the smartphone may show rapid acceleration. The data can be fused together at cloud 126 to reach a conclusion that the user may be at a fast moving vehicle. The conclusion can then be forwarded to the user or other entities if desired. The conventional methods are deficient in that the fusion and analysis step may take place on a cloud server. In addition, significant uplink power is consumed to communicate different sensor data from smartphone 110 to gateway 120. Finally, data communication between devices 102, 104 and 106 may interfere with the smartphone's other communication priorities (e.g., LTE, Wi-Fi and Cellular).

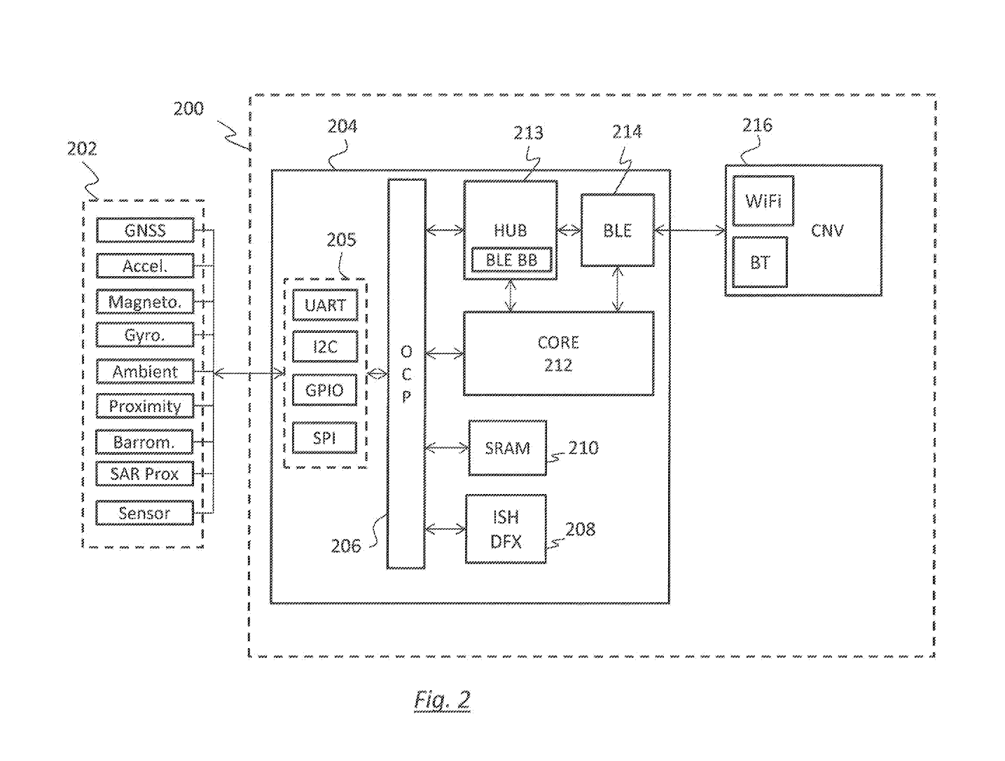

In one embodiment of the disclosure, data fusion and analysis occurs on an independent logic at smartphone 110 without awakening the platform (host) processor or communication modules. FIG. 2 shows a system according to one embodiment of the disclosure. System 200 of FIG. 2 receives signal communications from sensors 202. Exemplary sensors 202 include Global Navigation Satellite System (“GNSS”), Accelerometer, Magnetometer, Gryoscope, Ambient light sensor, Proximity sensor, Barometer, Proximity detector and Sensors. The Proximity detector determines proximity based on the specific absorption rate. Serial Peripheral Interface (SPI) is a serial bus protocol for connecting peripheral sensors to the core.

The sensors shown in FIG. 2 are not exhaustive and other sensors may be included without departing from the disclosed principles. One or more of these sensors may be implemented at a wearable device such as smartwatch or other biosensors.

Data from sensors 202 may be asynchronous. System 200 receives information from external sensors at receiver 205. Receiver 205 may define a conventional frontend receiver including universal asynchronous receiver/transmitter (UART) for translating data between parallel and serial forms. Receiver 205 may also include inter-integrated bus (I2C) for attaching low-speed peripherals to system 200, general purpose input/output (GPIO) as additional chip connectors and serial peripheral interface (SPI).

Sensor information is then communicated from receiver 205 to Open Core Protocol (OCP) 206. Open Core Protocol is a specification for various interconnects and fabrics on a system-on-chip (SOC). The OCP is an interconnect protocol that allows the different IP blocks to interact on a system-on-chip (OCP). OCP 206 may not be logically part of the core but can be physically implemented elsewhere. OCP 206 communicates with ISH DFX 2089, SRAM 210, Core 212 and HUB 213. ISH DFX handle any design for testing and manufacturing.

Static Random-Access Memory (SRAM) 210 may comprise one or more memory bi-stable latching circuitry to store bits of data. SRAM is shown as an exemplary embodiment and it may include any on-die memory or other memory circuitry. Core 212 may comprise a processor circuitry. For example, core 212 may comprise multi-core processor architecture or miniature processor architecture.

HUB 213 may be one or more processors combining to form the wearable IoT HUB. The one or more processors may comprise hardware, software logic or a combination thereof. BLE BB stack part of HUB 213 represents the implementation of the different layers of the BLE protocol. The implementation may be in hardware, software or a hybrid of hardware and software. The BLE BB stack determines priority of access to the medium and determines when what modes and services will be supported. The BLE BB stack also conditions data before it is passed to the physical layer for transmission/reception over the air.

In one embodiment, HUB 213 receives information from various sensors/IoT 202 and fuse the information based on given or known attributes to arrive at a meaningful conclusion. The information received from IoT or sensors 202 may comprise information relating to the user's movement or environment. For example, the information may include data relating to the user's walking pace or speed, acceleration or ambient lighting about the user. The information may be received from several different sources. For example, a wristwatch may provide ambient lighting information, a pedometer may provide movement information and the smartphone may provide acceleration information. By fusing this information, data analysis may be done to reach meaningful conclusions.

In an exemplary embodiment, data from the accelerometer, gyroscope, GNSS and strength of received wireless signals may be combined to determine a user's location (indoors or outdoors) with a high degree of precision and without consuming too much power. In another embodiment, data from pedometer, accelerometer and heart rate sensor may be combined to determine calories burnt.

Fused data may be analyzed based on a number of predefined criteria. Analysis may result in conclusions that require awakening the main CPU or connectivity mode. For example, fused data may contain data from several sources that form the basis of activity mapping. Communication or further analysis of this information may require additional computing or communication power. In such cases, HUB 213 may awaken the smartphone's connectivity module 216 or processor (not shown). Once the main connectivity module 216 is awakened, information may be transmitted to an external network or the cloud (e.g., cloud 130, FIG. 1).

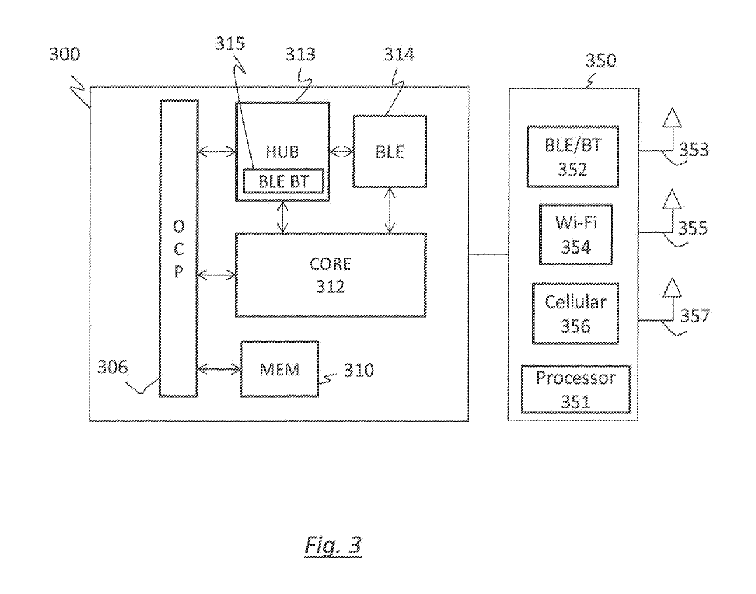

FIG. 3 is a schematic representation of a wearable or IoT hub according to one embodiment of the disclosure. Specifically, FIG. 3 shows Offload engine 300. Offload engine 300 may be formed as an integrated sensor used with wearable IoTs and other similar products. Offload engine 300 may be executed in one or more actual or virtual logic processors. Offload engine 300 is similar to that shown in FIG. 2 and includes bus 306, memory 310, core processor 312, HUB 313 and dedicated BLE radio 314. Offload engine 300 extends battery life of the smartphone or the platform it supports. The battery life is extended because the conventional connectivity solutions are designed to handle different applications with various distances and data rates serviced by different modulation and coding schemes. In contrast, Offload engine 300 communication and computation workload for interacting with wearable IoTs may be offloaded to dedicated BLE radio 314 and HUB 313.

In one embodiment of the disclosure, dedicated radio 314 may be integrated with HUB 312, core 312 and MEM 310 on a system-on-chip (SoC). The intermittent and sporadic workload and traffic of the IoT devices and applications may be handled by a short range, low data rate, power and duty-cycle optimized radio without waking up the connectivity chip and application processor on the main platform. Specifically, Offload engine 300 may be configured on a lower power processor configured for efficient power consumption. Offload engine 300 can post-process the sensor data for data fusion and analysis.

As shown in FIG. 3, Offload engine 300 also incorporates BLE communication HUB 314 for offloading from the apps processor the protocol stack and interface with main connectivity radio 350 for light traffic and workload applications. Host platform 350 includes processor circuitry 351, BLE/BT radio 352, Wi-Fi radio 354, cellular radio 356 and antennas 353, 355 and 357. While host platform 350 is shown with main connectivity modes including BLE/BT 352, Wi-Fi 354 and Cellular 356, the disclosed embodiments are not limited thereto and other connectivity modes may be included in host platform 350. Antennas 353, 355 and 357 may be configured to send and receive signals for one or more of the connectivity modes shown in FIG. 3.

As stated, Offload engine 300 interfaces with main connectivity radio 350 for light traffic and workload applications. Representatives examples of these applications include wireless service discovery and proximity sensing (see sensors 202, FIG. 2). The offloading of sensor and communications onto HUB 313 enables lower power dissipation by keeping the platform apps processor in sleep/standby mode for the wearable and/or IoT sensors and applications.

In FIG. 3, BLE baseband (BB) stack 315 is incorporated with HUB 313. BLE BB 315 is digital and may be optionally integrated with HUB 313 or it may be merged with BLE core 214. In the embodiment of FIG. 3, an optimized BT-BLE radio or radio-mode may be specifically optimized tor wearable IoT applications. BLE radio 314 can operate as an offload radio to handle the low-activity and short range wireless activity of wearable IoTs rather than using the main BT or BT with enhanced data rate (EDR) modes on the platform connectivity chip. The EDR version of BT Core Specification provides for faster data transfer at a nominal rate of about 3 Mbit/s. EDR uses a combination of different modulations to provide a lower power consumption through a reduced duty cycle. HUB 313 in Offload engine 300 with the BLE (or BT) radio 314 implements offloading so that the platform CPU (not shown) is not activated for communicating with and processing the wearable device data unless a specific CPU action is warranted. This reduces input/outputs and other non-essential circuits in the main platform connectivity chip (not shown) to save power. The Offload engine 300 may be used as the main compute and low-power connectivity mechanism for the wearable/IoT devices. It may also be used for offload radio applications. An offload radio can handles most or all communications at the low end and later hand off to the main radio at higher data rates to optimize (at higher data rates or longer range) the system for power efficiency and performance enhancement.

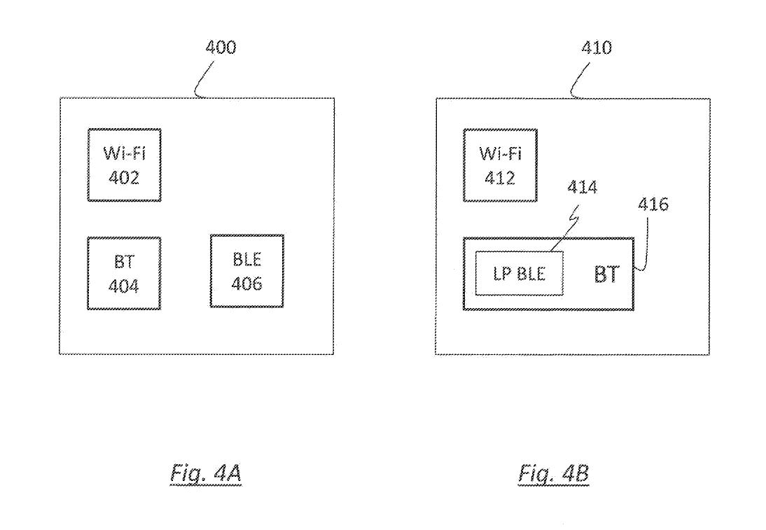

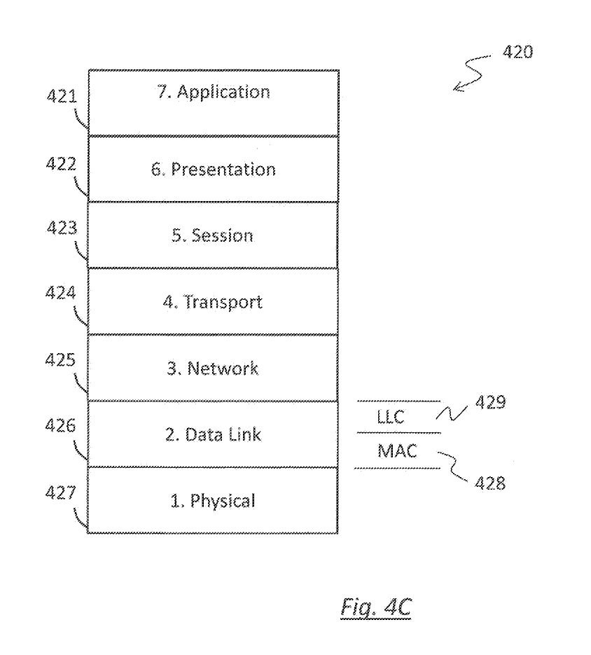

FIG. 4A schematically shows a conventional platform connectivity chip. The platform of FIG. 4A includes Wi-Fi communication mode 402, BT communication mode 404 and BLE communication mode 406. Each communication mode may include one or more processor and memory circuitry to conduct the communication mode. While not shown, the platform connectivity chip 400 communicates with other components (not shown) of the smartphone platform (not shown).

FIG. 4B schematically shows a platform connectivity chip according to one embodiment of the disclosure. In FIG. 4B, modified connectivity chip 410 includes Wi-Fi communication mode 412, BT mode 416 and low-power BLE 414. The low-power mode of the platform connectivity chip may be specifically optimized for wearable IoT devices. It may also be integrated with the sensor (i.e., as radio 314 in FIG. 3). The latter case can also use the higher layers (transport layer, session layer, presentation layer and application layer) of the BT/BLE protocol stack inside integrated sensor 313.

FIG. 4C illustrates a conventional architecture model for IEEE 802.11 protocol. The model includes layers 1-7, corresponding to the Physical (PHY) Layer 427, Data Link Layer 426, Network Layer 425, Transport Layer 424, Session Layer 423, Presentation Layer 422 and Application Layer 421. The Data Link layer includes two sub-layers: Logical Link Control (LLC) 429 and Media Access Control (MAC) 428.

In one embodiment, power savings for the optimized radio mode (314, FIG. 3) or radio (410, FIG. 4) may be achieved through several exemplary means. First, integrated communication HUB 300 of FIG. 3 may incorporate scheduling for the wireless communication to the wearable devices to that communication from IoT devices is slotted in idle times of the main platform connectivity chip and cellular radios (not shown). This scheduling substantially eliminates the need to support co-existence in the Radio Frequency Integrated Chip (“RFIC”) thus saving power through more linearity, more relaxed phase noise, etc. In an embodiment of the disclosure, the scheduling may occur inside HUB 313 (FIG. 3) to further streamline and reduce power consumption.

Second, the PHY and MAC layers (427, 428 at FIG. 4C) may be simplified as a result of the short range needed and the limited modes of operation. Supporting the IoT devices does not require EDR support, and is a purely peer-to-peer connection.

Third, the RFIC (e.g., BLE 214, FIG. 2; BLE 314, FIG. 3; LP BLE 414, FIG. 4B) may be specifically optimized for short-range, bursty communication with a lower power consumption For example, the output power of the power amplifier supporting the RFIC may be reduced and the RFIC may be configured with short turn on/off times for aggressive duty cycling.

In another embodiment of the disclosure, the dedicated low-power BLE radio-mode or the standalone radio will have relaxed specification because it supports short-distances and does not need to simultaneously coexist with other communication modes such as Wi-Fi or cellular. In an exemplary embodiment, the Wi-Fi and the BLE radios not need operate at the same instant in time. In one implementation the idle timeslots are used. In another embodiment, low power transmission is used for short communication distances. The low power transmission creates less opportunity for interaction between the radios. The disclosed embodiment does not use EDR and may be slotted to operate such that it does not interfere with platform simultaneous operation. As an estimate, the power dissipation of the optimized BT/BLE radio can be about 5-10 mW in active mode and in the nW-μW range in the sleep or standby mode. With aggressive duty cycling and fast on/off features the average power dissipation may be further reduced (e.g., to 5 μW assuming 0.1% duty cycling and the above estimates for active and standby power.

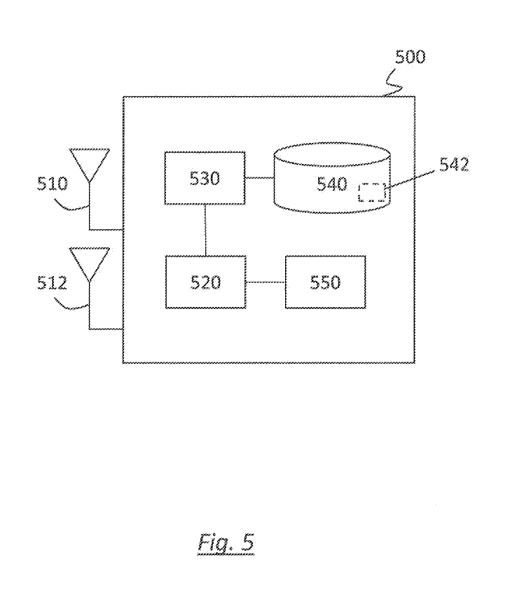

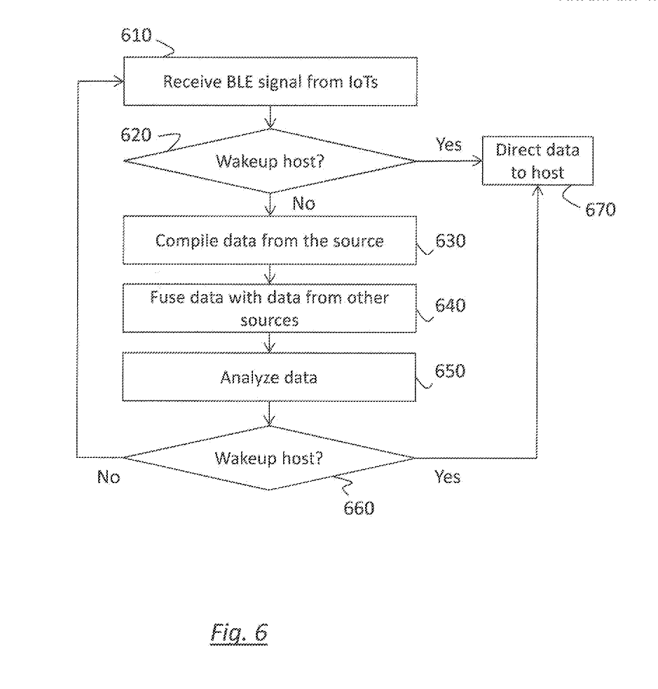

FIG. 5 is an exemplary system for implementing an embodiment of the disclosure. System 500 of FIG. 5 may comprise an AP or a smart wireless device capable of multimode communication. In an exemplary embodiment system 500 comprises a smartphone configured to communicate with wearable IoTs or other devices. System 500 includes antennas 510, 512, one or more platform radios 520 and platform processor 550. Platform radio and processor may support the main connectivity modes such as cellular or Wi-Fi. System 500 also includes Offload engine 500 which communicates with memory circuit 540. Memory circuit 540 may contain instructions 542 for actuating sensor HUB 530 and radios 520. While system 500 is shown with antenna 510 and 512, the disclosure is not limited to having two antennas. More or fewer antennas may be used to accommodate system 500 to process different communication modes.

Integrated sensor HUB 530 may include, among others, a sensor HUB and an optional dedicated BLE radio as shown with respect to FIG. 3. In one embodiment, signal(s) received at antenna 510 may be relayed to platform radio circuitry 520. Platform radio 520 may distinguish the source of the signal as wearable IoT or other sources. If the signal source is not a wearable IoT, then platform radio 520 may awaken processor 550 for further action. If the signal is from a wearable IoT, then platform radio 520 may direct the signal data to sensor HUB 530. In an embodiment where sensor HUB 530 comprises a dedicated BLE radio (not shown), the signal may be received directly at HUB 530 without awakening platform radio 520 or platform processor 550.

In one implementation, HUB 530 receives data from a plurality of wearable IoTs. The data may concern movement, acceleration, temperature, barometric pressure and other sensor data. HUB 530 may apply instructions 542 stored in memory 540 to analyze the data. HUB 530 may also fuse data from different wearable IoTs.

HUB 530 may compile, analyze and fuse wearable IoT data while keeping platform radio 520 and platform processor 550 in sleep mode. In another example, HUB 530 awakens platform processor 550 when additional processing capabilities are needed or when certain triggering event are sensed. A triggering event may be any event programmed into memory 540 that requires further action by the platform processor. For example, a triggering event may be if the wearable sensor on the user's body indicate elevated heart rate combined wither alone or in combination with other events (e.g., increased body temperature.) Once platform processor 550 is awakened, additional steps may be taken, for example, by reporting the exigent conditions through platform radio 520.

FIG. 6 is a flow diagram of an exemplary implementation of a process according to one embodiment of the disclosure. The steps shown in flow diagram of FIG. 6 may be stored at memory circuitry 540 as instructions to be implemented by sensor HUB 530 of FIG. 5. The steps of FIG. 6 may be implemented by one or more processor circuitries (e.g., sensor HUB) in communication with an integrated communication module. Alternatively, the communication module may be shared between the one or more processor circuitries and the connectivity module of the platform device (e.g., smartphone). The steps of FIG. 6 may also be implemented by one or more processor logics specifically configured to implement each step.

The process of FIG. 6 starts at step 610 when data is received from a wearable IoT. Step 610 may be performed by the Offload radio. At step 620 a determination is made as to whether to wake up the host computer or the platform processor. Pre-defined criteria may be used to help In the decision of step 620. If the decision is made to awaken the host, at step 670, the host is awakened and the data is directed thereto. If the decision is not to awaken the host, at step 630 additional data is gathered from the same or from different IoTs. At step 640, data is fused to data from other sources. Step 640 may be optionally implemented. At step 650, the gathered data is analyzed.

At step 660, an additional determination is made weather to awaken the host. If additional information from steps 630 to 650 warrant awakening the host computer, then the host is awakened, and data is directed thereto as shown in step 670. Otherwise, the flow diagram reverts back to step 610 and continues to gather wearable IoT data. While not shown additional steps may be included whereby the HUB actively interrogates the wearable sensors for additional information.

The following non-limiting examples illustrate different embodiments of the disclosure. Example 1 relates to an apparatus to communicate with a plurality of wearable sensors, comprising: a communication logic to communicate with one or more wearable sensors and with a connectivity mode of a host platform; and a first logic to combine incoming data from the one or more wearable sensors, the first logic configured to fuse incoming data from the one or more wearable sensors and to determine whether to awaken the host platform.

Example 2 relates to the apparatus of example 1, further comprising a second logic to communicate incoming data with the host platform.

Example 3 relates to the apparatus of example 2, wherein the first logic is further configured to schedule communication with the plurality of wearable sensors when a main connectivity radio of the host platform is inactive.

Example 4 relates to the apparatus of example 2, wherein the communication logic defines a low data rate, low-power, short-range wireless communication.

Example 5 relates to the apparatus of example 2, wherein the first logic is further configured to execute at least one of transport, session, presentation and application layers of a Bluetooth Low Energy (BLE) baseband protocol.

Example 6 relates to the apparatus of example 1, wherein the first logic maintains exclusive communication with the one or more wearable sensors.

Example 7 relates to the apparatus of example 1, wherein at least one of the communication logic or the first logic is integrated with the host platform.

Example 8 relates to the apparatus of example 1, wherein the first logic is further configured to form a data profile by fusing incoming data from the one or more wearable sensors.

Example 9 relates to the apparatus of claim 3, wherein the first logic is further configured to coordinate at least one of transmission or reception of data from the one or more wearable sensors with the host platform to reduce interference.

Example 10 relates to a system comprising: one or more antennas; a platform radio to communicate with the one or more antennas; a platform processor to communicate with the platform radio; and a first logic to combine incoming data from one or more wearable sensors, the first logic configured to fuse incoming data from the one or more wearable sensors and to determine whether to awaken the host platform.

Example 11 relates to the system of example 10, former comprising a second logic to communicate incoming data with the host platform.

Example 12 relates to the system of example 11, wherein the first logic is further configured to schedule communication with the plurality of wearable sensors when a main connectivity radio of the host platform is inactive.

Example 13 relates to the system of example 11, wherein the communication logic defines a low data rate, low-power, short-range wireless communication.

Example 14 relates to the system of example 11, wherein the first logic is further configured to execute at least one of transport, session, presentation and application layers of a Bluetooth Low Energy (BLE) baseband protocol.

Example 15 relates to the system of example 10, wherein the first logic maintains exclusive communication with the one or more wearable sensors.

Example 16 relates to the system of example 10, wherein at least one of the communication logic or the first logic is integrated with the host platform.

Example 17 relates to the system of example 10, wherein the first logic is further configured to form a data profile by fusing incoming data from the one or more wearable sensors.

Example 18 relates to a tangible machine-readable non-transitory storage medium that contains instructions, which when executed by one or more processors result in performing operations comprising: evaluating at a first logic information from one or more wearable sensors to determine whether to awaken the host computer; receiving incoming data from one or more wearable sensors; combining the incoming data from the one or more wearable sensors to form fused data; analyzing the fused data to form a data profile; and determine whether to awaken the platform processor as a function of the data profile.

Example 19 relates to the tangible machine-readable non-transitory storage medium of example 18, further comprising a second logic to communicate incoming data with the host platform.

Example 20 relates to the tangible machine-readable non-transitory storage medium of example 18, wherein the first logic is further configured to schedule communication with the plurality of wearable sensors when a main connectivity radio of the host platform is in sleep mode.

Example 21 relates to the tangible machine-readable non-transitory storage medium of example 20, wherein the communication logic defines a low data rate, low-power, short-range wireless communication.

Example 22 relates to the tangible machine-readable non-transitory storage medium of example 20, wherein the first logic is further configured to execute at least one of transport, session, presentation and application, layers of a Bluetooth Low Energy (BLE) baseband protocol.

Example 23 relates to the tangible machine-readable non-transitory storage medium of example 20, wherein the first logic maintains exclusive communication with the one or more wearable sensors.

While the principles of the disclosure have been illustrated in relation to the exemplary embodiments shown herein, the principles of the disclosure are not limited thereto and include any modification, variation or permutation thereof.

What is claimed is:

1. An apparatus to communicate with a plurality of wearable sensors, comprising:
a communication logic to communicate with one or more wearable sensors and with a connectivity mode of a host platform; and
a first logic to combine incoming data from the one or more wearable sensors, the first logic configured to fuse incoming data from the one or more wearable sensors and to determine whether to awaken the host platform.

2. The apparatus of claim 1, further comprising a second logic to communicate incoming data with the host platform.

3. The apparatus of claim 2, wherein the first logic is further configured to schedule communication with the plurality of wearable sensors when a main connectivity radio of the host platform is inactive.

4. The apparatus of claim 2, wherein the communication logic defines a low data rate, low-power, short-range wireless communication.

5. The apparatus of claim 2, wherein the first logic is further configured to execute at least one of transport, session, presentation and application layers of a Bluetooth Low Energy (BLE) baseband protocol.

6. The apparatus of claim 1, wherein the first logic maintains exclusive communication with the one or more wearable sensors.

7. The apparatus of claim 1, wherein at least one of the communication logic or the first logic is integrated with the host platform.

8. The apparatus of claim 1, wherein the first logic is further configured to form a data profile by fusing incoming data from the one or more wearable sensors.

9. The apparatus of claim 3, wherein the first logic is further configured to coordinate at least one of transmission or reception of data from the one or more wearable sensors with the host platform to reduce interference.

10. A system comprising:
one or more antennas;
a platform radio to communicate with the one or more antennas;
a platform processor to communicate with the platform radio; and
a first logic to combine incoming data from one or more wearable sensors, the first logic configured to fuse incoming data from the one or more wearable sensors and to determine whether to awaken the host platform.

11. The system of claim 10, further comprising a second logic to communicate incoming data with the host platform.

12. The system, of claim 11, wherein the first logic is further configured to schedule communication with the plurality of wearable sensors when a main connectivity radio of the host platform is inactive.

13. The system of claim 11, wherein the communication logic defines a low data rate, low-power, short-range wireless communication.

14. The system of claim 11, wherein the first logic is further configured to execute at least one of transport, session, presentation and application layers of a Bluetooth Low Energy (BLE) baseband protocol.

15. The system of claim 10, wherein the first logic maintains exclusive communication with the one or more wearable sensors.

16. The system of claim 10, wherein at least one of the communication logic or the first logic is integrated with the host platform.

17. The system of claim 10, wherein the first logic is further configured to form a data profile by fusing incoming data from the one or more wearable sensors.

18. A tangible machine-readable non-transitory storage medium that contains instructions, which when executed by one or more processors result in performing operations comprising:
evaluating at a first logic information from one or more wearable sensors to determine whether to awaken the host computer;
receiving incoming data from one or more wearable sensors;
combining the incoming data from the one or more wearable sensors to form fused data;
analyze the fused data to form a data profile; and
determining whether to awaken the platform processor as a function of the data profile.

19. The tangible machine-readable non-transitory storage medium of claim 18, further comprising a second logic to communicate incoming data with the host platform.

20. The tangible machine-readable non-transitory storage medium of claim 18, wherein the first logic is further configured to schedule communication with the plurality of wearable sensors when a main connectivity radio of the host platform is in sleep mode.

21. The tangible machine-readable non-transitory storage medium of claim 20, wherein the communication logic defines a low data rate, low-power, short-range wireless communication.

22. The tangible machine-readable non-transitory storage medium of claim 20, wherein the first logic is further configured to execute at least one of transport, session, presentation and application layers of a Bluetooth Low Energy (BLE) baseband protocol.

23. The tangible machine-readable non-transitory storage medium of claim 20, wherein the first logic maintains exclusive communication with the one or more wearable sensors.
